(19) United States
(12) Patent Application Publication
(10) Pub. No.: US 2021/0243685 A1
(43) Pub. Date: Aug. 5, 2021

(54) COMMUNICATION APPARATUS, CONTROL METHOD, AND COMPUTER-READABLE STORAGE MEDIUM

(71) Applicant: Canon Kabushiki Kaisha, Tokyo (JP)

(72) Inventor: Hideaki Tachibana, Kanagawa (JP)

(21) Appl. No.: 17/237,230

(22) Filed: Apr. 22, 2021

Related U.S. Application Data
(63) Continuation of application No. PCT/JP2019/038716, filed on Oct. 1, 2019.

(30) Foreign Application Priority Data
Oct. 22, 2018 (JP) 2018-198712

(51) Int. Cl. H04W 48/18

(52) U.S. Cl. CPC H04W 48/18; H04W 84/12

(57) ABSTRACT

A communication apparatus participates in a network that mutually connects base stations that provide a communication service to a terminal, determines, in accordance with whether the apparatus can be connected to a public network in the network without via another apparatus, whether the apparatus operates as a role of a controller that controls the network or as a role of an agent that is managed by another apparatus that operates as the controller, and operates as a function corresponding to the determination.

### CROSS-REFERENCE TO RELATED APPLICATIONS

This application is a Continuation of International Patent Application No. PCT/JP2019/038716, filed Oct. 1, 2019, which claims the benefit of Japanese Patent Application No. 2018-198712, filed Oct. 22, 2018, both of which are hereby incorporated by reference herein in their entirety.

### BACKGROUND OF THE INVENTION

### Field of the Invention

The present invention relates to a communication apparatus, a control method, and a computer-readable storage medium and, more particularly, to an automatic network setting technique.

### Background Art

The Wi-Fi® Alliance formulated the Wi-Fi EasyMesh standard. According to Wi-Fi EasyMesh, in a network constituted by a plurality of access points (APs), various types of information concerning the APs are obtained, and efficient network control among a plurality of APs is performed based on the obtained information. In Wi-Fi EasyMesh, each AP functions as a controller apparatus that manages an overall network by controlling other APs or an agent apparatus that notifies the controller apparatus of network information under the control of the controller apparatus. The controller apparatus collects topology information and discovery information from the agent apparatus, and performs network control by transmitting instructions to the agent apparatus based on these pieces of information. The controller apparatus also performs proxy control for data communication and data traffic management between the network controlled by the apparatus itself and a public network (or at least a network outside the network controlled by the apparatus itself). PTL 1 discloses a technique by which a controller apparatus performs steering in accordance with radio intensity with respect to a station (STA) connected to an AP by using IEEE1905.1.

### CITATION LIST

### Patent Literature

PTL 1: US-2018-0176284

It is assumed that a user selects a controller apparatus from a plurality of apparatuses existing in a Wi-Fi EasyMesh network. In this case, however, the user may not select an apparatus suitable as a controller apparatus but may select another apparatus as a controller because, for example, the user has no knowledge about the network. In such a case, the user may not be able to use a communication function that should be available.

### SUMMARY OF THE INVENTION

The present invention provides a technique that makes it possible to automatically and more properly select a controller that controls a network from apparatuses belonging to the network.

A communication apparatus according to one aspect of the present invention comprises a participation unit configured to participate in a network that mutually connects base stations that provide a communication service to a terminal, a determination unit configured to determine, in accordance with whether the apparatus can be connected to a public network in the network without via another apparatus, whether the apparatus operates as a role of a controller that controls the network or as a role of an agent that is managed by another apparatus that operates as the controller, and an operation unit configured to operate as a function corresponding to determination made by the determination unit.

Further features of the present invention will become apparent from the following description of exemplary embodiments with reference to the attached drawings.

### BRIEF DESCRIPTION OF THE DRAWINGS

FIG. 1 is a view showing a first example of the configuration of a communication system;

FIG. 2A is a block diagram showing an example of the configuration of a digital camera;

FIG. 2B is a perspective view showing an example of the configuration of the digital camera;

FIG. 2C is a perspective view showing an example of the configuration of the digital camera:

FIG. 3 is a block diagram showing an example of the configuration of a smart device;

FIG. 4A is a flowchart showing an example of the procedure of processing executed by the digital camera and the smart device;

FIG. 4B is a flowchart showing an example of the procedure of processing executed by the digital camera and the smart device;

FIG. 4C is a flowchart showing an example of the procedure of processing executed by the digital camera and the smart device;

FIG. 5 is a sequence chart showing a first example of the procedure of processing;

FIG. 6A is a flowchart showing an example of the procedure of processing executed by the digital camera and the smart device;

FIG. 6B is a flowchart showing an example of the procedure of processing executed by the digital camera and the smart device;

FIG. 7 is a view showing a second example of the configuration of a communication system; and

FIG. 8 is a sequence chart showing a second example of the procedure of processing.

### DESCRIPTION OF THE EMBODIMENTS

An embodiment of the present invention will be described below with reference to the accompanying drawings. Note that the present invention is not limited by the individual embodiments to be described below, and various changes and modifications of the embodiments to be described below can be made within the spirit and scope of the present invention.

(System Configuration)

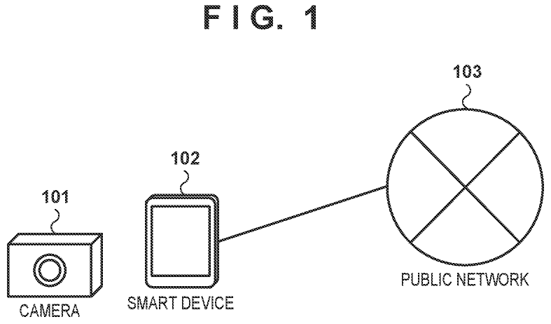

FIG. 1 shows an example of the configuration of a wireless communication system according to this embodiment. The wireless communication system includes, for example, a camera 101 and a smart device 102. The camera 101 and the smart device 102 are communication apparatuses that can mutually transmit and receive signals by wireless communication. Note that the smart device 102 is connected to a public network 103. In this embodiment, the camera 101 and the smart device 102 construct a Wi-Fi EasyMesh network. Note that the Wi-Fi EasyMesh network is an example, and the following discussion can be applied to an arbitrary network that mutually connects base stations (access points) that provide communication services for terminals. In addition, the public network in the embodiment includes wide area external networks such as the Internet and a WAN (Wide Area Network), and includes an arbitrary network outside the Wi-Fi EasyMesh network.

(Configuration of Camera 101)

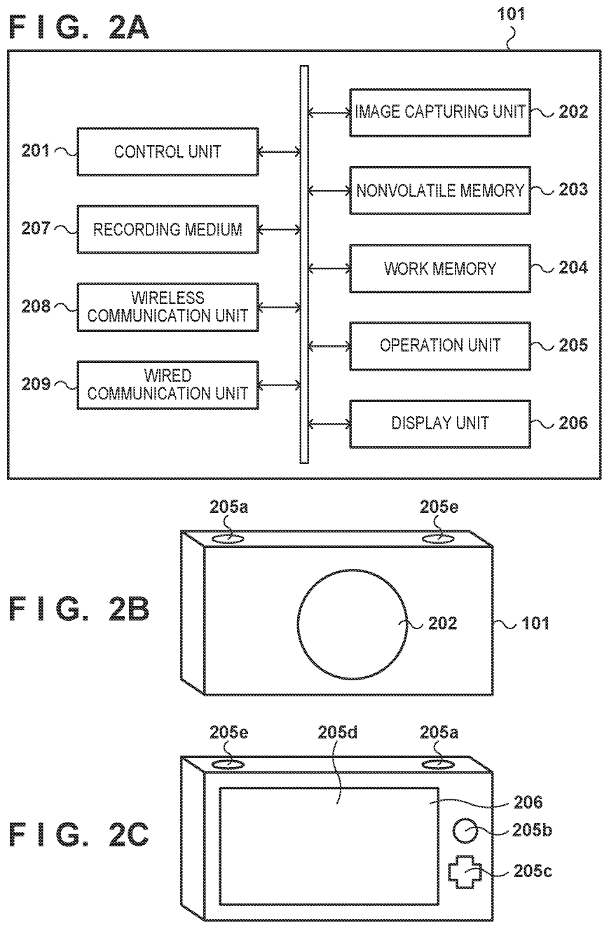

The configurations of the camera 101 and the smart device 102 will be described next. FIG. 2A shows an example of the configuration of the camera 101. The camera 101 can be an image capturing apparatus such as a digital camera, and can be, for example, an apparatus having an image capturing function such as a portable media player, a tablet computer, or a personal computer or an arbitrary information processing apparatus other than the image capturing apparatus. The camera 101 includes, for example, a control unit 201, an image capturing unit 202, a nonvolatile memory 203, a work memory 204, an operation unit 205, a display unit 206, a recording medium 207, a wireless communication unit 208, and a wired communication unit 209. Note that these functional units are exemplary, and the camera 101 can be replaced with an apparatus having an arbitrary configuration as long as it can execute various types of processing (to be described later).

The control unit 201 includes, for example, one or more general-purpose processors such as a CPU (Central Processing Unit) and an MPU (Micro Processing Unit) and a processor such as an ASIC (Application Specific Integrated Circuit). Note that the control unit 201 may include a gate array circuit such as an FPGA (Field Programmable Gate Array) configured to execute predetermined processing. The control unit 201 controls the overall camera 101 in accordance with input signals and programs (to be described later), and executes the processing of each flowchart (to be described later). Note that the overall camera 101 may be controlled by making a plurality of pieces of hardware share processing instead of making the control unit 201 control the overall apparatus.

The image capturing unit 202 includes, for example, an optical lens unit, an optical system that performs, for example, aperture control, zoom control, and focus control, and an image sensor for converting light (video) introduced through the optical lens unit into an electrical video signal. In this case, the image capturing unit 202 can use, for example, a CMOS (Complementary Metal Oxide Semiconductor) or a CCD (Charge Coupled Device) as an image sensor. The image capturing unit 202 converts the object light imaged by a lens into an electrical signal by using an image sensor under the control of the control unit 201, and performs noise reduction processing, thereby outputting digital data as image data. The camera 101 records image data on the recording medium 207 in accordance with, for example, the DCF (Design Rule for Camera File system) standard.

The nonvolatile memory 203 is an electrically erasable programmable nonvolatile memory and stores, for example, programs (to be described later) executed by the control unit 201. The work memory 204 is used as a buffer memory that temporarily holds image data captured by the image capturing unit 202, an image display memory of the display unit 206, a work area of the control unit 201, or the like.

The operation unit 205 is used to receive instructions for the camera 101 from the user. The operation unit 205 includes a power button for allowing the user to issue an instruction to turn on/off the power supply of the camera 101, a release switch for issuing an instruction to perform image capturing, and a playback button for issuing an instruction to play back image data. The operation unit 205 can further include operation members such as a dedicated connection button for starting communication with an external device via the wireless communication unit 208 (to be described later). In addition, the operation unit 205 can include a touch panel formed on the display unit 206 (to be described later).

The display unit 206 displays viewfinder images at the time of image capturing, captured image data, characters for interactive operations, and the like. The display unit 206 also displays code information such as barcodes, two-dimensional codes, and QR Codes®. The camera 101 can be connected to an internal or external display apparatus and may have display control function of controlling display on the display apparatus in addition to or in place of the display unit 206.

Examples of the operation unit 205 and the display unit 206 will be described below with reference to the perspective views of FIGS. 2B and 2C showing an example of the configuration of the camera 101. The operation unit 205 includes, for example, operation members such as a release switch 205a, a playback button 205b, a direction key 205c, a touch panel 205d, and a power switch 205e. In this case, the touch panel 205d also functions as the display unit 206. Note that the display unit 206 need not be a touch panel. In this case, the display unit 206 is physically separated from the operation unit 205.

The recording medium 207 is, for example, an arbitrary device that can record information, and can record image data output from the image capturing unit 202. The recording medium 207 may be a medium such as a memory card that is detachably mounted in the camera 101, a memory built in the camera 101, or the like. The camera 101 has at least a function of accessing the recording medium 207.

The wireless communication unit 208 is a wireless communication interface for connection to an external apparatus. The camera 101 can directly transmit and receive data to and from an external apparatus having a similar wireless communication interface via the wireless communication unit 208. Note that the camera 101 is connected to a relay apparatus (for example, an external AP) via the wireless communication unit 208, and can also communicate with a communication partner apparatus via the relay apparatus. The wireless communication unit 208 can perform communication in either an AP (access point) mode or an STA (station) mode. In the AP mode, the wireless communication unit 208 is connected to another apparatus operating as an STA. In the STA mode, the wireless communication unit 208 is connected to another apparatus operating as an AP. Note that in this embodiment, the wireless communication unit 208 includes an interface for communication with an external apparatus via a wireless LAN complying with the IEEE802.11 standard series. The camera 101 can wirelessly communicate with an external apparatus by, for example, making the control unit 201 control the wireless communication unit 208. The camera 101 also executes communication parameter sharing processing for sharing wireless communication parameters to be set in the wireless communication unit 208 with an external apparatus by, for example, making the control unit 201 control the wireless communication unit 208. In communication parameter sharing processing, a communication parameter providing apparatus provides a communication parameter reception apparatus with communication parameters for wireless communication. In this case, the communication parameters include wireless communication parameters necessary for wireless LAN communication, such as Service Set Identifier (SSID) as a network identifier, an encryption method, an encryption key, an authentication method, and an authentication key. The communication parameters also include a MAC address, a passphrase, an IP address for communication on the IP layer, and information necessary for high-order services. Communication parameter sharing processing may be performed by a method (to be referred to as WPS hereinafter) complying with the Wi-Fi Protected Setup standard defined by the Wi-Fi alliance or by a method (to be referred to as DPP hereinafter) complying with the Device Provisioning Protocol standard. Note that the wireless communication unit 208 performs communication via a wireless LAN in this embodiment. However, communication may be performed by a wireless communication method/system other than a wireless LAN.

The wired communication unit 209 is a wired communication interface for connection to an external apparatus. The camera 101 can directly transmit and receive data to and from an external apparatus having a similar wired communication interface via the wired communication unit 209. Note that the camera 101 is connected to a relay apparatus (for example, an external router) via the wired communication unit 209, and can communicate with a communication partner apparatus via the relay apparatus. Note that in this embodiment, the wired communication unit 209 includes an interface for communication with an external apparatus via a wired LAN (Ethernet®) complying with the IEEE802.3 standard. The camera 101 can perform wired communication with an external apparatus by, for example, making the control unit 201 control the wired communication unit 209. Note that the wired communication unit 209 may perform communication in accordance with standards other than the Ethernet standard.

Note that in the camera 101 according to this embodiment, the control unit 201 comprehensively performs wireless communication complying with the IEEE802.11 standard of the wireless communication unit 208 and wired communication complying with the IEEE802.3 standard of the wired communication unit 209 in accordance with the IEEE1905.1 standard. In the camera 101 according to the embodiment, the control unit 201 controls the wireless communication unit 208 to function as a role of a controller apparatus or a role of agent apparatus of the EasyMesh and perform control corresponding to the function. Note that in IEEE1905.1, an OSI reference model (seven) layer is a higher-order protocol than a PHY/MAC layer and is an abstraction layer for communication between an agent and a controller regardless of whether access points are connected to each other via a wireless LAN or wired LAN.

(Configuration of Smart Device)

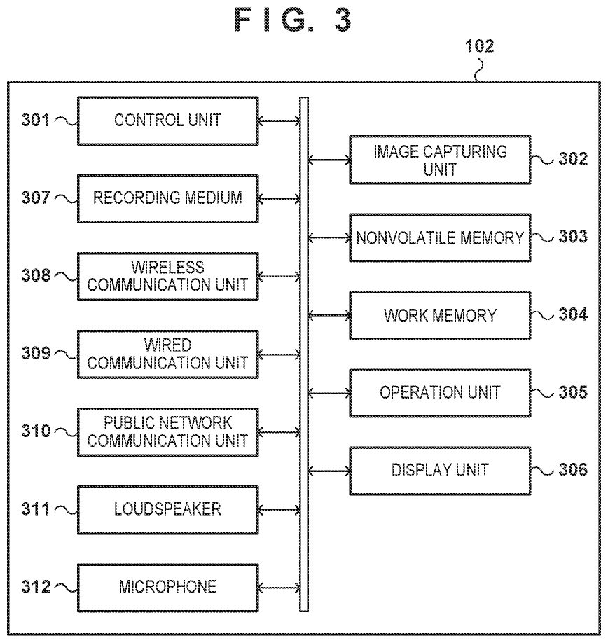

FIG. 3 shows an example of the configuration of the smart device 102. The smart device 102 is, for example, a smartphone, but may be an arbitrary information processing apparatus having a wireless function other than a smartphone, such as a portable phone, a personal computer, tablet, smart watch, or camera. The smart device 102 includes, for example, a control unit 301, an image capturing unit 302, a nonvolatile memory 303, a work memory 304, an operation unit 305, a display unit 306, a recording medium 307, a wireless communication unit 308, and a wired communication unit 309. The smart device 102 further includes a public network communication unit 310, a loudspeaker 311, and a microphone 312.

The control unit 301 includes, for example, one or more general-purpose processors such as a CPU and an MPU and a processor such as an application processor or ASIC (Application Specific Integrated Circuit). Note that the control unit 301 may include a gate array circuit such as an FPGA configured to execute predetermined processing. The control unit 301 controls the overall smart device 102 in accordance with input signals and programs (to be described later), and executes the processing of each flowchart (to be described later). Note that the overall smart device 102 may be controlled by making a plurality of pieces of hardware share processing instead of making the control unit 301 control the overall apparatus.

The image capturing unit 302 includes, for example, an optical lens unit, an optical system, and an image sensor. The image capturing unit 302 has a function similar to the image capturing unit 202 of the camera 101. The image data obtained by image capturing is stored in, for example, a buffer memory (for example, the work memory 304). The result obtained by the control unit 301 by performing a predetermined operation for the image data is recorded on the recording medium 307.

The nonvolatile memory 303 is an electrically erasable programmable nonvolatile memory. The nonvolatile memory 303 records an OS (operating system) as basic software executed by the control unit 301 and applications that implement applicative functions in cooperation with the OS. The OS is installed in the smart device 102. This OS can execute applications installed in the smart device 102. In addition, in this embodiment, the nonvolatile memory 303 stores application software for communication with the camera 101. The work memory 304 is used as a buffer memory that temporarily holds image data captured by the image capturing unit 302, an image display memory of the display unit 306, a work area of the control unit 301, or the like.

The operation unit 305 is used to receive instructions for the smart device 102 from the user. The operation unit 305 includes, for example, a power button for allowing the user to issue an instruction to turn on/off the power supply of the smart device 102 and an operation member such as a touch panel formed on the display unit 306. The display unit 306 displays image data, characters for interactive operations, and the like. The display unit 306 can also display code information such as two-dimensional codes including barcodes and QR codes. The smart device 102 can be connected to an internal or external display apparatus and may have a display control function that controls display on the display apparatus in addition to or in place of the display unit 306.

The recording medium 307 is, for example, an arbitrary device that can record information, and can record image data output from the image capturing unit 302. The recording medium 307 may be a medium such as a memory card that is detachably mounted in the smart device 102, a memory built in the smart device 102, or the like. The smart device 102 has at least a function of accessing the recording medium 307.

The wireless communication unit 308 is a wireless communication interface for connection to an external apparatus. The smart device 102 can directly transmit and receive data to and from an external apparatus having a similar wireless communication interface via the wireless communication unit 308. Note that the smart device 102 is connected to a relay apparatus (for example, an external AP) via the wireless communication unit 308, and can also communicate with a communication partner apparatus via the relay apparatus. The wireless communication unit 308 can perform communication in either the AP (access point) mode or the STA (station) mode. Note that in this embodiment, the wireless communication unit 308 includes an interface for communication with an external apparatus via a wireless LAN complying with the IEEE802.11 standard series. The smart device 102 can wirelessly communicate with an external apparatus by, for example, making the control unit 301 control the wireless communication unit 308. The smart device 102 also executes the above communication parameter sharing processing for sharing wireless communication parameters to be set in the wireless communication unit 308 with an external apparatus by, for example, making the control unit 301 control the wireless communication unit 308. Communication parameter sharing processing may be performed by the WPS method defined by the Wi-Fi alliance or by the DPP method. Note that the wireless communication unit 308 performs communication via a wireless LAN in this embodiment. However, communication may be performed by a wireless communication method/system other than a wireless LAN.

The wired communication unit 309 is a wired communication interface for connection to an external apparatus. The smart device 102 can directly transmit and receive data to and from an external apparatus having a similar wired communication interface via the wired communication unit 309. Note that the smart device 102 is connected to a relay apparatus (for example, an external router) via the wired communication unit 309, and can communicate with a communication partner apparatus via the relay apparatus. Note that in this embodiment, the wired communication unit 309 includes an interface for communication with an external apparatus via a wired LAN (Ethernet®) complying with the IEEE802.3 standard. The smart device 102 can perform wired communication with an external apparatus by, for example, making the control unit 301 control the wired communication unit 309. Note that the wired communication unit 309 may perform communication in accordance with standards other than the Ethernet standard.

Note that in the smart device 102 according to this embodiment, the control unit 301 comprehensively performs wireless communication complying with the IEEE802.11 standard of the wireless communication unit 308 and wired communication complying with the IEEE802.3 standard of the wired communication unit 309 in accordance with the IEEE1905.1 standard. In the smart device 102 according to the embodiment, the control unit 301 controls the wireless communication unit 308 to function as a role of a controller apparatus or a role of agent apparatus of the EasyMesh and perform control corresponding to the function.

The public network communication unit 310 is a wireless communication interface used to perform public wireless communication (for example, wireless communication in a cellular system). The smart device 102 is connected, via the public network communication unit 310, to a base station apparatus having a corresponding wireless communication interface, and can perform calls and communication with another device via the base station apparatus. At this time, the control unit 301 inputs and outputs speech signals via the microphone 312 and the loudspeaker 311 to perform calls by using the smart device 102. In this embodiment, the public network communication unit 310 includes an antenna. The control unit 301 can be connected to a public network via the antenna. The control unit 301 can also relay communication with another communication apparatus connected by the wireless communication unit 308 or the wired communication unit 309 by using the public network communication unit 310. This allows another communication apparatus to be connected to the public network via the smart device 102. In this embodiment, the public network communication unit 310 performs communication in compliance with the LTE-Advanced standard defined in the third generation partnership project (3GPP). However, the public network communication unit 310 may be connected to the public network in accordance with standards other than the LTE-Advanced standard. The public network communication unit 310 may be, for example, a functional unit that is connected to a second network different from a first network, which is local, to which the camera 101 and the smart device 102 are connected. That is, the smart device 102 need not always be connected to a public network.

(Procedure of Processing)

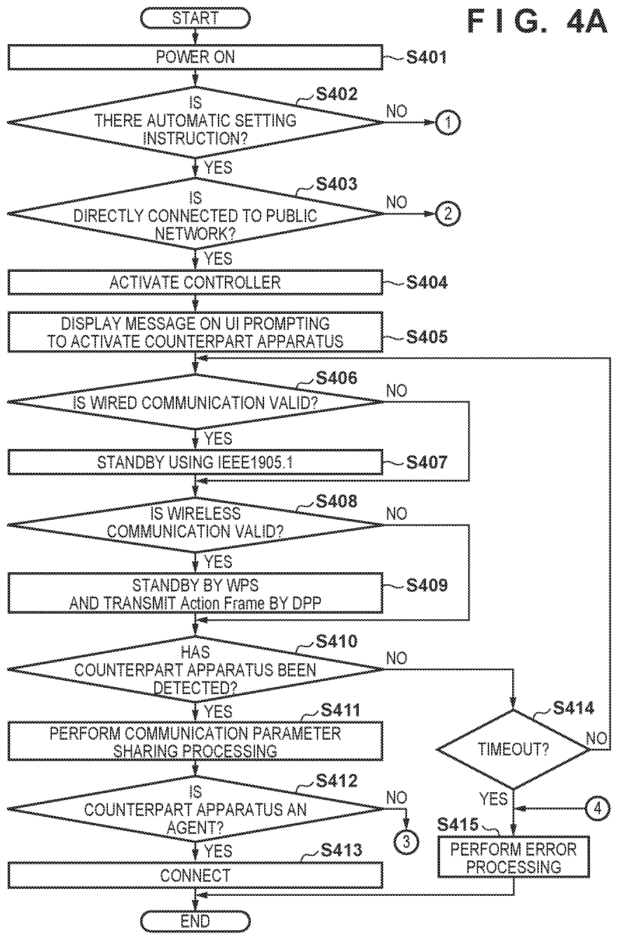

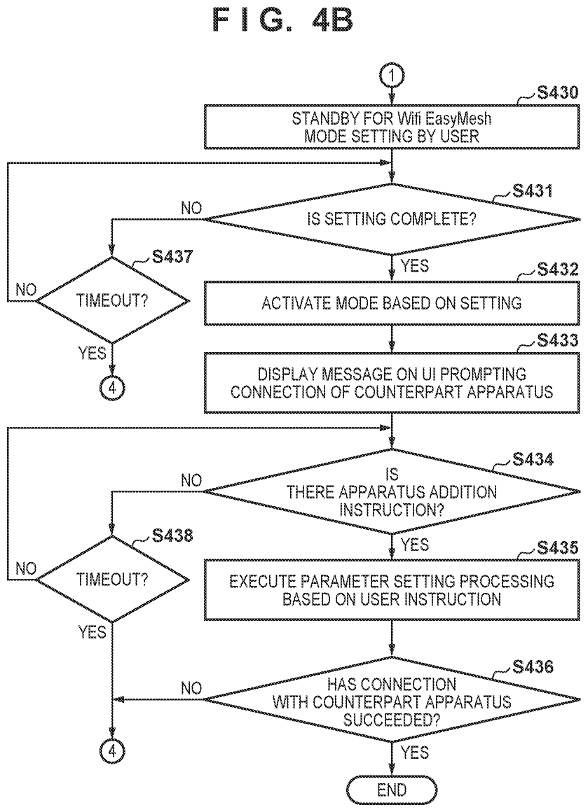

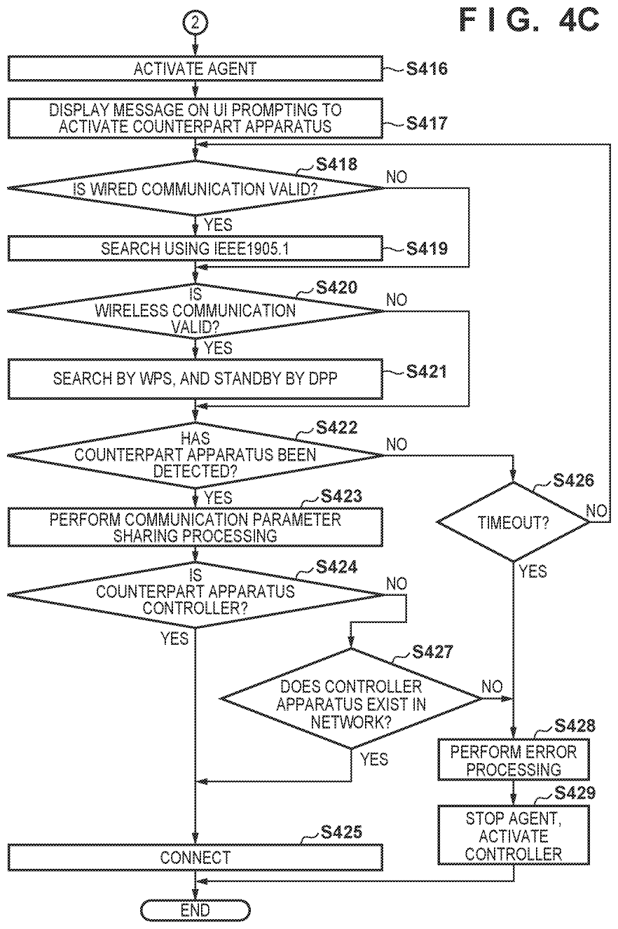

An example of the procedure of processing executed by the camera 101 and the smart device 102 according to this embodiment will be described next with reference to FIGS. 4A to 4C. The control unit 201 (control unit 301) executes the processing in FIGS. 4A to 4C by reading out computer programs stored in the nonvolatile memory 203 (nonvolatile memory 303). Note that part or all of the processing in FIGS. 4A to 4C may be implemented by hardware such as an ASIC. In the following description, when there is no need to discriminate the camera 101 and the smart device 102, they are called “apparatuses”.

First of all, the apparatus is activated when it receives a user's power-on operation (step S401). Note that when the apparatus has been powered on, the processing in step S401 can be omitted. The apparatus then determines whether a controller apparatus/agent apparatus automatic selection function is activated by, for example, a user's operation (step S402). Note that this automatic selection function may be, for example, remotely activated from another apparatus, and need not always be activated by a user's operation. Upon determining that the automatic selection function is activated (YES in step S402), the apparatus shifts the process to step S403. In step S403, the apparatus determines whether the apparatus itself can be directly connected to a public network by using the wireless communication unit, wired communication unit, or public network communication unit. The apparatus performs this determination by, for example, determining whether the public network communication unit of the apparatus exists in a service area of cellular communication services, whether the wireless communication unit is ready to be connected to a public wireless LAN, or whether the wired communication unit is connected to a public network. Alternatively, when, for example, the apparatus has a communication unit that can be connected to a public network but its function is OFF (for example, the public network communication unit is set in the flight mode), the apparatus can determine that it cannot be directly connected to the public network. Note that “directly” in this determination may be interpreted as being connected without via another apparatus participating in the Wi-Fi EasyMesh network. That is, when the apparatus can be connected to a public network via another apparatus that is not participating in the same Wi-Fi EasyMesh network as that in which the apparatus itself is participating without via another apparatus that is participating in the Wi-Fi EasyMesh network, the apparatus can determine that it can be directly connected to the public network. Upon determining that the apparatus can be directly connected to the public network (YES in step S403), the apparatus activates the controller function (step S404). That is, when the apparatus according to this embodiment can be directly connected to the public network, the apparatus operates as a Wi-Fi EasyMesh controller apparatus. The processing from step S404 (to be described below) to step S414 (to be described later) is an example of the procedure of processing when the apparatus operates as a controller apparatus.

Upon starting an operation as a controller apparatus, the apparatus displays a predetermined message prompting the user to activate the counterpart apparatus (step S405). When the apparatus has detected an already activated counterpart apparatus, the predetermined message need not be displayed. In addition, the apparatus may display a screen indicating that the apparatus is operating as a controller apparatus and is ready to be connected to an agent apparatus. Note that information display is not limited to visual display and may include information presentation by sound, vibration, or the like. Subsequently, the apparatus determines whether wired communication by the apparatus itself is valid (step S406). Upon determining that wired communication is valid (YES in step S406), the apparatus starts search processing for a counterpart apparatus which is defined in the IEEE1905.1 standard (step S407). In contrast to this, upon determining that wired communication is not valid (NO in step S406), the apparatus does not execute search processing for a counterpart apparatus according to the IEEE1905.1 standard. Subsequently, the apparatus determines whether wireless communication by the apparatus itself is valid (step S408). Upon determining that wireless communication by the apparatus itself is valid (YES in step S408), the apparatus activates the AP mode of the wireless communication unit to construct a Wi-Fi EasyMesh network with a Fronthaul SSID. Upon constructing a network, the apparatus starts communication parameter sharing processing. In this case, since the apparatus has started an operation as a controller apparatus in step S404, the apparatus operates as a providing apparatus in communication parameter sharing processing. That is, the apparatus operates as Registrar in WPS and operates as Configurator in DPP. The apparatus starts WPS standby processing and counterpart apparatus search processing by DPP (step S409). For example, the apparatus performs WPS Probe Request reception standby and Action Frame transmission processing by DPP. Note that upon determining that wireless communication of the apparatus itself is invalid (NO in step S408), the apparatus does not execute the processing in step S409.

Subsequently, the apparatus determines whether a counterpart apparatus has been detected as a result of a search for a counterpart apparatus by using the wireless communication unit or wired communication unit (step S410). Upon detecting a counterpart apparatus (YES in step S410), the apparatus shifts the process to step S411. Upon detecting no counterpart apparatus (NO in step S410), the apparatus shifts the process to step S414.

In step S411, the apparatus performs communication parameter sharing processing between itself and the counterpart apparatus. Upon executing the communication parameter sharing processing between itself and the counterpart apparatus, the apparatus determines whether the counterpart apparatus is an agent apparatus (step S412). Upon determining that the counterpart apparatus is an agent apparatus (YES in step S412), the apparatus is connected to the counterpart apparatus (step S413). If the wireless function of the apparatus is valid, the counterpart apparatus performs wireless connection as a Backhaul STA by using the parameters received in the communication parameter sharing processing with respect to the Fronthaul SSID network constructed by using the wireless communication unit in step S409. That is, in this case, the apparatus operates as an AP, and the counterpart apparatus operates as an STA, thereby performing inter-AP communication together. That is, the apparatus performs inter-AP mesh network communication in a Wi-Fi EasyMesh network by operating as an AP with respect to an STA connected to the Wi-Fi EasyMesh network. On the other hand, the counterpart apparatus operates as an STA in inter-AP mesh network communication in the Wi-Fi EasyMesh network, and operates as an AP with respect to the STA connected to the Wi-Fi EasyMesh network. Subsequently, the apparatus and the counterpart apparatus execute processing defined in the IEEE1905.1 standard to share communication parameters on a high-order layer. If the wired function is valid, the apparatus skips wireless connection processing and executes processing defined in the IEEE1905.1 standard for sharing the communication parameters on the high-order layer by using the wired communication unit. This makes it possible to connect the apparatus to the counterpart apparatus not only on the low-order layer but also on the high-order layer.

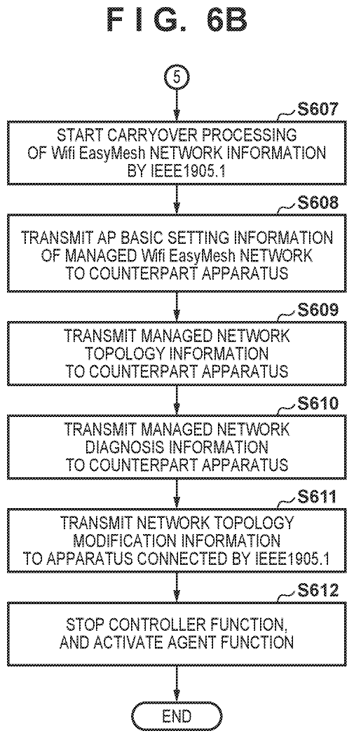

Upon determining that the counterpart apparatus is not an agent apparatus (NO in step S412), the apparatus shifts the process to the processing shown in FIGS. 6A and 6B. Note that the processing in FIGS. 6A and 6B will be described later.

In step S414, the apparatus determines whether a timeout has occurred in the automatic selection function. If a timeout has occurred in the automatic selection function (YES in step S414), the apparatus executes error processing (step S415). Note that in the error processing, the apparatus notifies the user of the occurrence of an error via the display unit and stops the automatic selection function. Note that the apparatus may perform error processing other than that described above. For example, the apparatus may cause the display unit to display a message inquiring the user whether to continue the automatic selection function. If no timeout has occurred in the automatic selection function (NO in step S414), the apparatus returns the process to step S406.

Upon determining that the apparatus cannot be directly connected to the public network (NO in step S403), the apparatus activates the agent function (step S416). That is, in this embodiment, the apparatus that cannot be directly connected to the public network operates as a Wi-Fi EasyMesh agent apparatus. The processing from step S416 (to be described below) to step S429 (to be described later) is an example of the procedure of processing when the apparatus functions as an agent apparatus.

Upon starting an operation as an agent apparatus, the apparatus displays, on the display unit, a predetermined message prompting the user to activate the counterpart apparatus (step S417). When the apparatus has detected an already activated counterpart apparatus, the predetermined message need not be displayed. In addition, the apparatus may display a screen indicating that the apparatus is operating as an agent apparatus and is ready to be connected to a controller apparatus. Note that information display is not limited to visual display and may include information presentation by sound, vibration, or the like. Subsequently, the apparatus determines whether wired communication by the apparatus itself is valid (step S418). Upon determining that wired communication is valid (YES in step S418), the apparatus starts search processing for a counterpart apparatus which is defined in the IEEE1905.1 standard by using the wired communication unit (step S419). In contrast to this, upon determining that wired communication is not valid (NO in step S418), the apparatus does not execute search processing for a counterpart apparatus defined in the IEEE1905.1 standard. Subsequently, the apparatus determines whether wireless communication by the apparatus itself is valid (step S420). Upon determining that wireless communication by the apparatus itself is valid (YES in step S420), the apparatus activates the STA mode of the wireless communication unit to start counterpart apparatus search processing by WPS and DPP standby processing (step S421). Upon starting Wi-Fi EasyMesh network search processing, the apparatus starts communication parameter sharing processing. In this case, the apparatus operates as an agent apparatus in step S416 and hence operates as a reception apparatus in the communication parameter sharing processing. That is, the apparatus operates as Enrollee in WPS and DPP. The apparatus executes search processing by WPS and counterpart apparatus standby processing by DPP by using the wireless communication unit. For example, the apparatus performs WPS Probe Request transmission processing and Action Frame reception processing by DPP. Note that upon determining that the wireless communication of the apparatus itself is invalid (NO in step S420), the apparatus does not execute the processing in step S421.

Subsequently, the apparatus determines whether a counterpart apparatus has been detected as a result of a search for a counterpart apparatus by using the wireless communication unit or wired communication unit (step S422). Upon detecting a counterpart apparatus (YES in step S422), the apparatus shifts the process to step S423. Upon detecting no counterpart apparatus (NO in step S422), the apparatus shifts the process to step S426.

In step S423, the apparatus performs communication parameter sharing processing between itself and the counterpart apparatus by wireless communication or wired communication. Upon executing the communication parameter sharing processing between itself and the counterpart apparatus, the apparatus determines whether the counterpart apparatus is a controller apparatus (step S424). Upon determining that the counterpart apparatus is a controller apparatus (YES in step S424), the apparatus is connected to the counterpart apparatus (step S425). If the wireless function of the apparatus is valid, the counterpart apparatus performs wireless connection as a Backhaul STA by using the parameters received in the communication parameter sharing processing with respect to the Fronthaul SSID network constructed by using the wireless communication unit. Subsequently, the apparatus and the counterpart apparatus execute processing defined in the IEEE1905.1 standard to share communication parameters on a high-order layer. If the wired function is valid, the apparatus skips wireless connection processing and executes processing defined in the IEEE1905.1 standard for sharing the communication parameters on the high-order layer by using the wired communication unit. This makes it possible to connect the apparatus to the counterpart apparatus not only on the low-order layer but also on the high-order layer.

In contrast to the above, upon determining that the counterpart apparatus is not a controller apparatus (NO in step S424), the apparatus determines whether a controller apparatus exists on the Wi-Fi EasyMesh network (step S427). That is, the apparatus determines whether a controller apparatus exists prior to a counterpart apparatus as an agent apparatus. If a controller apparatus exists on the Wi-Fi EasyMesh network (YES in step S427), the apparatus shifts the process to step S425 to perform connection processing between itself and the counterpart apparatus. Note that the apparatus may perform connection processing between itself and the controller apparatus in the Wi-Fi EasyMesh network. In contrast to this, if no controller apparatus exists (NO in step S427), the apparatus performs error processing (step S428). The error processing can be processing similar to that in step S415 described above. In the error processing, the apparatus may display a message prompting the user of the controller apparatus to perform designation. The apparatus may terminate the processing upon executing the error processing in step S428, or the apparatus itself may start an operation as a controller apparatus upon stopping the agent function (step S429).

In step S426, the apparatus determines whether a timeout has occurred in the automatic selection function. If a timeout has occurred in the automatic selection function (YES in step S426), the apparatus executes error processing (step S428). Note that if no timeout has occurred in the automatic selection function (NO in step S428), the apparatus returns the process to step S418.

The process returns to step S402. Upon determining that the automatic selection function is not activated (NO in step S402), the apparatus shifts the process to step S430. In this case, the apparatus makes transition to a state in which the apparatus accepts setting in the Wi-Fi EasyMesh network manually set by the user without using the automatic selection function. The processing in step S430 to step S439 to be described below is an example of processing in this state.

In step S430, the apparatus stands by for the input of a Wi-Fi EasyMesh mode setting by a user's operation. In this case, the mode setting is a setting for a mode which indicates whether the apparatus operates as either a controller apparatus or an agent apparatus. Upon detecting that the mode setting by a user's operation is not completed (NO in step S431), the apparatus determines whether the period during which a user's operation for the mode setting is accepted has expired (step S437). If the period has expired without accepting any user's operation for mode setting and the apparatus detects a timeout (YES in step S437), the apparatus executes error processing (step S415). In contrast to this, if the apparatus has not detected a timeout in a user's operation for mode setting (NO in step S437), the apparatus returns the process to step S431. If the apparatus has detected that mode setting by a user's operation is completed (YES in step S431), the apparatus activates an operation mode as a controller apparatus or agent apparatus based on the setting (step S432). The apparatus then displays, on the display unit, a predetermined message prompting the user to activate the counterpart apparatus (step S433). The apparatus determines whether an instruction to connect to the counterpart apparatus is issued by a user's operation (step S434).

If an instruction to connect to the counterpart apparatus is issued by a users operation (YES in step S434), the apparatus executes communication parameter sharing processing between itself and the counterpart apparatus based on a user instruction (step S435). Upon executing this communication parameter sharing processing, the apparatus determines whether connection to the counterpart apparatus has succeeded (step S436). If connection to the counterpart apparatus has failed (NO in step S436), the apparatus executes error processing (step S415).

If an instruction to connect to the counterpart apparatus has not been issued by a user's operation (NO in step S434), the apparatus determines whether the period during which a user's operation concerning an instruction to connect to the counterpart apparatus is accepted has expired (step S438). If the period has expired without accepting any user's operation concerning an instruction to connect to the counterpart apparatus has expired and the apparatus has detected a timeout (YES in step S438), the apparatus executes error processing (step S415). Note that each error processing described above is performed in the above manner, and hence a description of the processing will be omitted. In contrast to this, if the apparatus has not detected a timeout in a user's operation concerning an instruction to connect to the counterpart apparatus (NO in step S438), the apparatus returns the process to step S434.

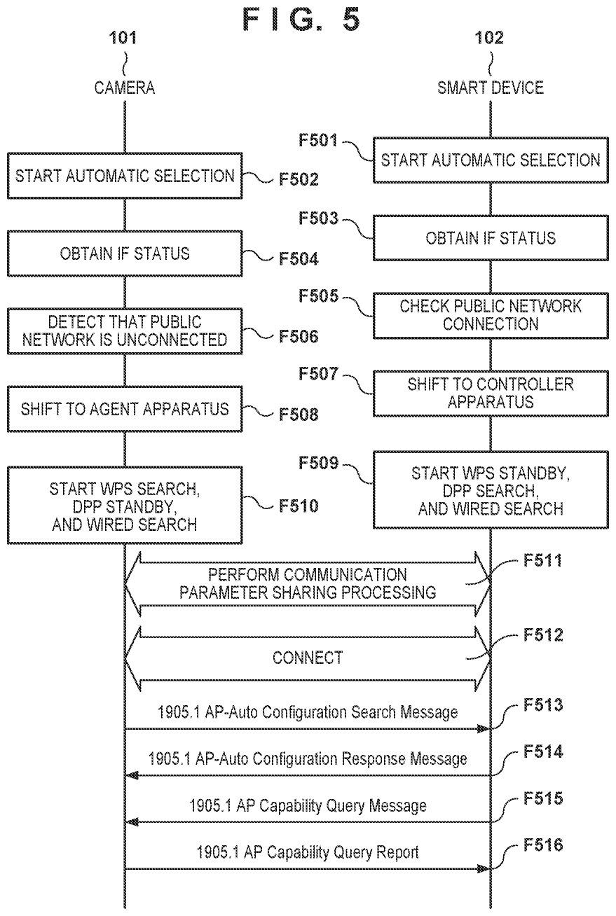

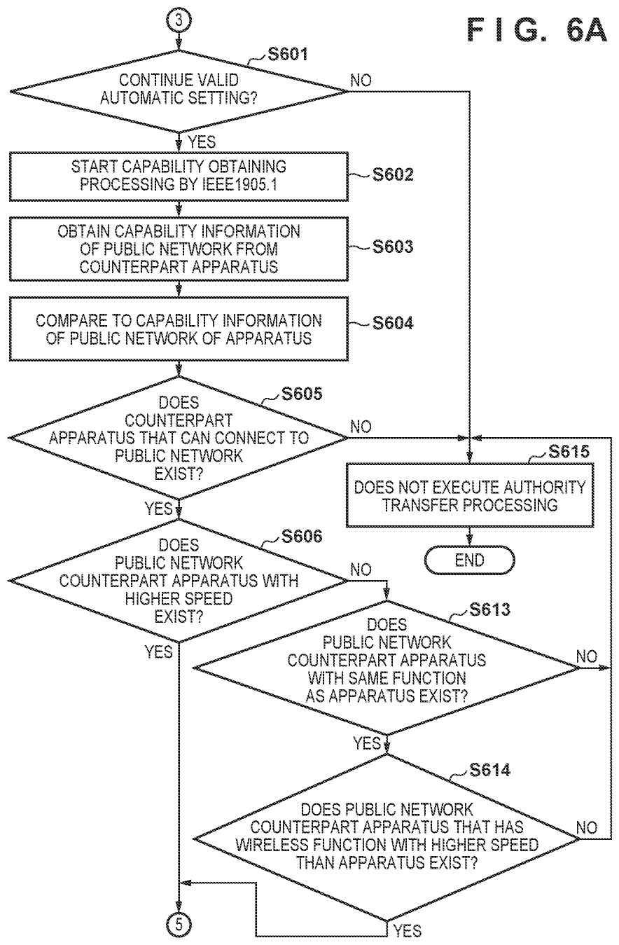

An outline of processing until a Wi-Fi EasyMesh network is constructed between the camera 101 and the smart device 102 in accordance with the processing in FIGS. 4A to 4C will be described next with reference to FIG. 5. The example in FIG. 5 is an example of the procedure of processing in the state shown in FIG. 1.

In this processing, first of all, the smart device 102 causes the operation unit 305 to, for example, accept a predetermined user's operation of selecting the controller apparatus/agent apparatus automatic selection function, and activates the automatic selection function (F501). Likewise, the camera 101 accepts a predetermined operation from the operation unit 205, and activates the controller apparatus/agent apparatus automatic selection function (F502). Upon activating the automatic selection function, the smart device 102 checks the statuses of the wireless communication unit 308, the wired communication unit 309, and the public network communication unit 310, and checks whether the apparatus itself is ready to be directly connected to the public network (F503). Likewise, upon activating the automatic selection function, the camera 101 checks the statuses of the wireless communication unit 208 and the wired communication unit 209, and checks whether the apparatus itself is ready to be directly connected to the public network (F504).

Assume that in this embodiment, the smart device 102 detects that the public network communication unit 310 is connected to the public network, and the camera 101 detects that it cannot be connected to the public network via the wireless communication unit 208 and the wired communication unit 209 (F505 and F506). In this case, since the smart device 102 has detected that the public network communication unit 310 is connected to the public network, the device determines that the role of the device itself is a controller apparatus and activates the controller function (F507). When constructing a Wi-Fi Easy Mesh network by wireless, the smart device 102 activates the AP mode of the wireless communication unit 308 and constructs a Fronthaul SSID network. Since the camera 101 has detected that it cannot be connected to the public network, the camera determines that the role of the apparatus itself is an agent apparatus and activates the agent function (F508). When participating in a Wi-Fi EasyMesh network by wireless connection, the camera 101 activates the STA mode of the wireless communication unit 208 and starts network participation processing as a Backhaul STA (F508).

Upon constructing a network by activating the controller function, the smart device 102 starts communication parameter sharing processing. In the communication parameter sharing processing, as described above, the parameter providing apparatus provides a parameter reception apparatus with communication parameters for wireless communication. In this case, the controller apparatus becomes an apparatus that provides communication parameters. That is, the smart device 102 as a controller apparatus becomes Registrar in WPS and Configurator in DPP. In this case, communication parameter sharing processing is executed by using WPS and DPP. However, other protocols may be used. The smart device 102 controls the wireless communication unit 308 so as to start WPS standby processing and counterpart apparatus search processing by DPP (F509), and execute the processing concurrently (or time-divisionally). For example, the smart device 102 controls the wireless communication unit 308 so as to perform search processing by Probe Request reception for WPS and Action Frame transmission for DPP. The smart device 102 controls the wired communication unit 309 so as to start counterpart apparatus search processing defined in the IEEE1905.1 standard (F509).

Upon starting network participation processing by activating the agent function, the camera 101 starts communication parameter sharing processing like the smart device 102. The agent apparatus becomes an apparatus that receives communication parameters. That is, the camera 101 as the agent apparatus becomes Enrollee in WPS and DPP. The camera 101 controls the wireless communication unit 208 so as to start counterpart apparatus search processing by WPS and DPP standby processing (F510), and execute the processing concurrently (or time-divisionally). For example, the camera 101 controls the wireless communication unit 208 so as to perform search processing by Probe Request transmission and Action Frame reception by DPP. The camera 101 also controls the wired communication unit 209 so as to start counterpart apparatus search processing defined in the IEEE1905.1 standard (F510).

The smart device 102 performs communication parameter sharing processing by using the wireless communication unit 308 or the wired communication unit 309, whereas the camera 101 performs communication parameter sharing processing by using the wireless communication unit 208 or the wired communication unit 209 (F511). In this case, communication parameter sharing processing is performed by wireless communication. However, communication parameter sharing processing may be performed by wired communication. The camera 101 performs wireless connection as a Backhaul STA by using the parameters received by communication parameter sharing processing with respect to the Fronthaul SSID network constructed by the smart device 102 (F512). In this case, the camera 101 establishes connection on a low-order layer such as a physical layer and a MAC (medium access control) layer. Note that in this embodiment, communication parameter sharing processing by both WPS and DPP can be executed but may be executed by only one of them.

The camera 101 transmits IEEE1905.1 AP-Auto Configuration Search Message to share communication parameters on a higher-order layer than a MAC layer by using the wireless communication unit 208 (F513). Upon receiving this message, the smart device 102 transmits IEEE1905.1 AP-Auto Configuration Response Message as a response signal by using the wireless communication unit 308 (F514). With this operation, the camera 101 and the smart device 102 recognize each other as a device complying with IEEE1905.1. Note that the smart device 102 may transmit IEEE1905.1 AP-Auto Configuration Search Message by using the wireless communication unit 308. In this case, the camera 101 can transmit IEEE1905.1 AP-Auto Configuration Response Message as a response signal by using the wireless communication unit 208.

Subsequently, the smart device 102 transmits IEEE1905.1 AP Capability Query Message to the camera 101 by using the wireless communication unit 308 in order to obtain AP information (F515). Upon receiving this message, the camera 101 transmits IEEE1905.1 AP Capability Query Report as a response signal to the smart device 102 by using the wireless communication unit 208 (F516). AP Capability Query Report includes, for example, information (STA Link Metrics) indicating the state of a wireless link. AP Capability Query Report also includes information concerning HT/VHT/HE Capabilities. This information can indicate whether the wireless communication unit 208 of the camera 101 supports each of IEEE802.11n (HT), IEEE802.11ac (VHT), and IEEE802.11ax (HE). AP Capability Query Report can also include RCPI-based Steering information. RCPI stands for Received Channel Power Indicator. This information indicates whether to correspond to steering based on RCPI. In addition. AP Capability Query Report may include information concerning Radio Basic Capabilities. This information indicates basic capability concerning radio. In addition, AP Capability Query Report may include information other than these pieces of information. This AP Capability Query allows the smart device 102 operating as a controller apparatus to obtain information concerning the camera 101 operating as an agent apparatus.

Note that the smart device 102 may transmit IEEE1905.1 AP Capability Query Message including information concerning the apparatus itself. The camera 101 may also transmit IEEE1905.1 AP Capability Query Message, and the smart device 102 may transmit IEEE1905.1 AP Capability Query Report. That is, in the above case, the camera 101 notifies the smart device 102 of each type of information. However, the smart device 102 may notify the camera 101 of similar information. This notification may be mutually performed or performed with respect to either one of them as long as an apparatus operating as a controller apparatus can eventually obtain each type of information.

The above processing allows the smart device 102 to control a mesh network providing connection among APs with the apparatus itself or the camera 101 being an AP. Note that another apparatus operating as a terminal (STA) can sufficiently receive communication services via the mesh network regardless of whether the apparatus is connected to the camera 101 or the smart device 102 operating as an AP.

As described above, each apparatus according to this embodiment automatically determines apparatuses serving as a controller apparatus and an agent apparatus based on whether the apparatus itself can be directly connected to a public network. That is, each apparatus operates as a role of a controller apparatus when it can be directly connected to a public network, and operates as a role of an agent apparatus when it cannot be directly connected to the public network. According to this operation, each apparatus automatically determines to operate as either a controller apparatus or an agent apparatus. This makes it unnecessary for the user to manually make the above setting. In addition, this inhibits any apparatus that cannot be directly connected to a public network from operating as a controller, and hence can prevent, for example, any available communication function from not being able to be used. This can improve the convenience of the system.

Processing in a case in which when the apparatus starts operating as a controller apparatus (step S404), the counterpart apparatus is also a controller apparatus (the counterpart apparatus is not an agent apparatus (NO in step S412)) will be described next with reference to FIGS. 6A and 6B. The control unit of each apparatus performs the processing in FIGS. 6A and 6B by reading out and executing computer programs stored in a nonvolatile memory or the like. Note that part or all of the processing in FIGS. 6A and 6B may be implemented by hardware such as an ASIC.

The apparatus determines whether the controller apparatus/agent apparatus automatic selection function continues (step S601). If the apparatus itself does not continue the automatic selection function (NO in step S601), the apparatus determines not to transfer authority as a controller apparatus to the counterpart apparatus (step S615), and terminates the processing. In contrast to this, if the apparatus itself continues the automatic selection function (YES in step S601), the apparatus transmits IEEE1905.1 AP Capability Query Message to the counterpart apparatus to obtain information concerning the counterpart apparatus (step S602). Subsequently, the apparatus receives IEEE1905.1 AP Capability Query Report from the counterpart apparatus (step S603). AP Capability Query Report includes information concerning the capability of a public network in the counterpart apparatus. This information can include, for example, information indicating whether the counterpart apparatus is being connected to the public network and information such as the communication rate and capacity of the public network. Although AP Capability Query Report can include information like that described above other than this, a detailed description will be omitted. Note that these messages are transmitted and received by using the wireless communication unit or wired communication unit.

The apparatus compares the obtained information concerning the public network of the counterpart apparatus with information concerning the public network to which the apparatus itself is being connected (step S604). The apparatus determines, based on the information concerning the public network of the counterpart apparatus, whether the counterpart apparatus can be directly connected to the public network (step S605). In the following description, a counterpart apparatus that can be directly connected to a public network will be referred to as a public network counterpart apparatus. If the counterpart apparatus cannot be directly connected to the public network (NO in step S605), the apparatus determines not to transfer authority as a controller apparatus to the counterpart apparatus (step S615), and terminates the processing. In contrast to this, if the counterpart apparatus can be directly connected to the public network (YES in step S605), the apparatus then determines whether the communication rate when the public network counterpart apparatus communicates via the public network is higher than the communication rate when the apparatus itself communicates via the public network (step S606). Note that the apparatus can execute this determination based on the throughput, actual measurement value concerning communication quality, and system capacity of the apparatus itself in the public network and those of the public network counterpart apparatus in the public network. Upon determining that the communication rate when the public network counterpart apparatus communicates via the public network is higher (YES in step S606), the apparatus shifts the process to step S607. In contrast to this, upon determining that the communication rate when the apparatus itself communicates via the public network is higher (NO in step S606), the apparatus shifts the process to step S613.

In step S607, the apparatus determines to transfer controller apparatus authority to the public network counterpart apparatus that is determined in step S606 to be able to perform high-speed communication, and starts transmission processing of information for making the public network counterpart apparatus inherit network information. In this processing, the apparatus can transmit IEEE1905.1 AP Metrics Query Message including the basic setting information of an AP belonging to the EasyMesh network to the target counterpart apparatus (step S608). The apparatus then transmits, to the target counterpart apparatus, IEEE1905.1 Topology Notification Message including network topology information (configuration information) concerning a Wi-Fi EasyMesh network (step S609). In addition, the apparatus may transmit Multi-AP Policy Config Request Message in IEEE1905.1 to the target counterpart apparatus to make the counterpart apparatus inherit the poly information of the Wi-Fi EasyMesh network.

The apparatus also transmits, to the target counterpart apparatus, diagnosis information indicating the communication state of each apparatus in the interval from the construction of a Wi-Fi EasyMesh network to the present time (step S610). The apparatus then transmits IEEE1905.1 Topology Notification Message indicating that the network configuration information has been changed to each apparatus connected to the apparatus itself (step S611). Note that the messages in steps S607 to S611 are transmitted via, for example, the wireless communication unit of wired communication unit. Thereafter, the apparatus stops the controller function and activates the agent function (step S612).

In step S613, the apparatus determines whether the apparatus itself and the public network counterpart apparatus have similar public network throughput performance. Upon determining that the apparatus itself and the public network counterpart apparatus do not have similar public network performance (NO in step S613), that is, the public network performance of this public network counterpart apparatus is relatively low, the apparatus terminates the processing without transferring authority as a controller apparatus to the counterpart apparatus (step S615). In contrast to this, upon determining that the apparatus itself and the public network counterpart apparatus have similar public network performance (YES in step S613), the apparatus compares the wireless communication rate (for example, the throughput) of the apparatus itself with that of the public network counterpart apparatus (step S614). Upon determining that the wireless communication rate of the public network counterpart apparatus is higher (YES in step S614), the apparatus shifts the process to step S607, and transfers controller apparatus authority to this public network counterpart apparatus. Upon determining that wireless communication rate of the apparatus itself is higher (NO in step S614), the apparatus terminates the processing without transferring controller apparatus authority to this public network counterpart apparatus (step S615).

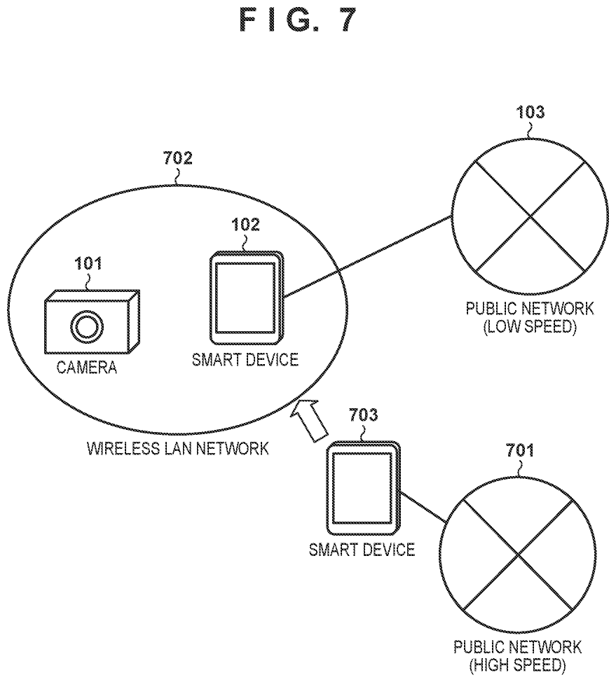

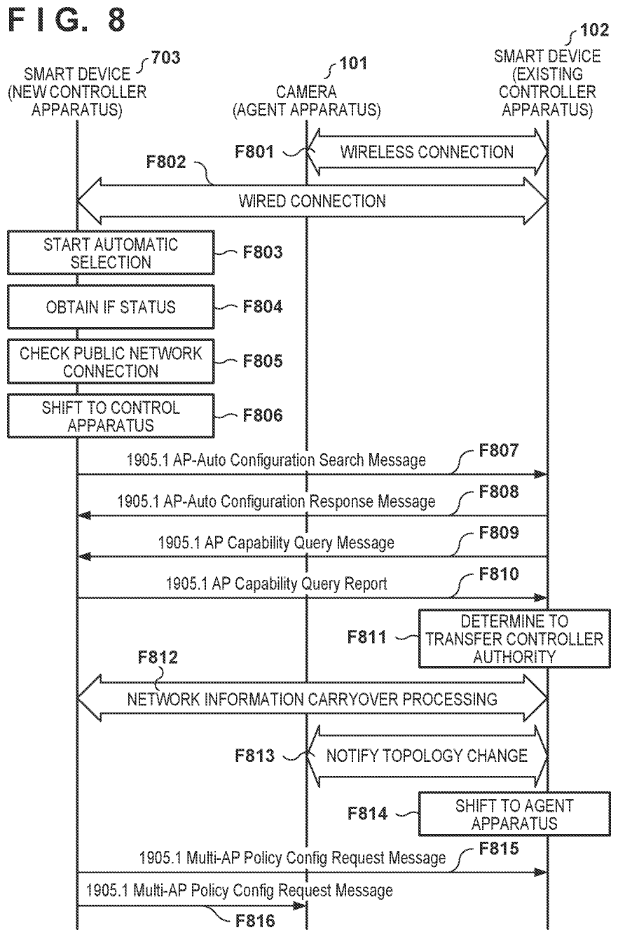

An outline of processing until a Wi-Fi EasyMesh network is constructed in accordance with the processing in FIGS. 4A to 4C and FIGS. 6A and 6B will be described next with reference to FIG. 8. Note that the example in FIG. 8 is an example of the procedure of processing in the state shown in FIG. 7. Referring to FIG. 7 as well, a Wi-Fi EasyMesh network is constructed between the camera 101 and the smart device 102 in the above manner. In this case, the smart device 102 operates as a controller apparatus in a Wi-Fi EasyMesh network, and a Fronthaul SSID wireless LAN network 702 is constructed. The camera 101 operates as an agent apparatus in the Wi-Fi EasyMesh network and is wirelessly connected to the wireless LAN network 702 as Backhaul STA.

Assume that in this state, a smart device 703 that can be connected to a public network 701 newly participates in this Wi-Fi EasyMesh network. Note that the communication rate (throughput) of the public network 701 is higher than that of the public network 103 to which the smart device 102 can be connected. For example, when the public network 701 is an LTE-Advanced network and the public network 103 is an LTE network, such a communication rate difference can occur. Assume that the smart device 102 and the smart device 703 can be connected to the same system (for example, an LTE-Advanced network), and a communication rate restriction is imposed on the smart device 102. In this case, such a communication rate difference occurs. In addition, for example, even when the smart device 102 and the smart device 703 can be connected to the same system, such a communication rate difference can occur depending on the performance difference between the smart device 102 and the smart device 703 or terminal category. As described above, although a communication rate difference can occur in the public network of smart devices depending on various conditions including the above conditions as well as additional conditions, each apparatus can recognize the communication rate difference by determining at least one of these conditions. Note that the smart device 703 and the smart device 102 have similar configurations as shown in FIG. 3.

In the processing shown in FIG. 8, the smart device 102 and the camera 101 are already wirelessly connected (F801). Assume, in this case, that the smart device 102 continues the above controller apparatus/agent apparatus automatic selection function. Assume also that the smart device 102 and the smart device 703 have established wired connection (F802). The following description is based on the assumption that the smart device 102 is wiredly connected to the smart device 703. However, the following discussion can be applied to a case in which wired connection is replaced with wireless connection. The smart device 703 starts processing in and after step S402 in FIG. 4A in response to, for example, this wired connection. First of all, the smart device 703 activates the controller apparatus/agent apparatus automatic selection function in response to a user's operation (F803) and checks the states of the wireless communication unit 308, the wired communication unit 309, and the public network communication unit 310 (F804). In this case, the smart device 703 checks which communication unit (for example, the public network communication unit 310) allows the device to be directly connected to the public network (F805), and activates the controller function (F806).

The smart device 703 then transmits IEEE1905.1 AP-Auto Configuration Search Message to the smart device 102 to set communication parameters on a higher-order layer than a MAC layer (F807). The smart device 102 transmits, to the smart device 703, IEEE1905.1 AP-Auto Configuration Response Message as a response signal to this message (F808). This makes the smart device 102 and the smart device 703 recognize each other as an IEEE1905.1 device. The smart device 102 then transmits IEEE1905.1 AP Capability Query Message to the smart device 102 to obtain AP information (F809). The smart device 703 transmits IEEE1905.1 AP Capability Query Report to the smart device 102 (F810). IEEE1905.1 AP Capability Query Report can include information indicating whether the smart device 703 is being connected to the public network and information such as the communication rate and capacity of the public network. Note that since the smart device 102 and the smart device 703 have established wired connection, each device can transmit and receive these messages by using the wired communication unit 309.

Note that the smart device 102 may transmit IEEE1905.1 AP-Auto Configuration Search Message. In this case, the smart device 703 can transmit IEEE1905.1 AP-Auto Configuration Response Message as a response signal to the above signal. The smart device 102 can also transmit IEEE1905.1 AP Capability Query Message including information concerning the apparatus itself. In addition, the smart device 703 may transmit IEEE1905.1 AP Capability Query message, and the smart device 102 may transmit IEEE1905.1 AP Capability Query Report. That is, in the above case, the smart device 703 notifies the smart device 102 of various types of information. However, the smart device 102 can notify the smart device 703 of similar information.

The smart device 102 compares the obtained information concerning the public network of the smart device 703 with information concerning a public network to which the apparatus itself is connected. Upon determining that the public network to which the smart device 703 is connected that is higher in communication rate than the public network to which the apparatus itself is connected can be obtained, the smart device 102 determines to transfer controller apparatus authority to the smart device 703 (F811). Note that the smart device 703 can perform similar determination. In this case, however, since the apparatus determines that the public network to which the smart device 102 is connected is lower in performance than the public network to which the apparatus itself is connected, the apparatus determines not to transfer controller apparatus authority.

The smart device 102 transmits information for the inheritance of existing Wi-Fi EasyMesh network information to the smart device 703 in accordance with the determination of transfer of controller apparatus authority (F812). The information transmitted in this case can include, for example, the basic setting information of APs belonging to the existing Wi-Fi EasyMesh network, his information can be transmitted with, for example, IEEE1905.1 AP Metrics Query Message. The smart device 102 can transmit, to the smart device 703, IEEE1905.1 Topology Notification Message including Wi-Fi EasyMesh network configuration information in F812. In addition, the smart device 102 may transmit, to the smart device 703, information for the inheritance of Wi-Fi EasyMesh network policy information. This information is transmitted with, for example, IEEE1905.1 Multi-AP Policy Config Request Message.

The smart device 102 then notifies the camera 101 of network configuration information because the Wi-Fi EasyMesh network configuration is changed (F813). The network configuration information includes at least controller apparatus information, agent apparatus information, or STA information. This notification is transmitted with, for example, extended IEEE1905.1 Topology Notification Message. Upon transmitting these messages, the smart device 102 stops the controller function and activates the agent function (F814).

The smart device 703 transmits information for the transmission of Wi-Fi EasyMesh network policy information to the camera 101 and the smart device 102 (F815 and F816). Note that this information is transmitted with, for example, IEEE1905.1 Multi-AP Policy Config Request Message. Multi-AP Policy Config Request Message includes network policy information (for example, STA steering information).

This processing makes the smart device 102 transfer controller apparatus authority to the smart device 703, thus updating the Wi-Fi EasyMesh network. Note that in the above case, the smart device 102 that has been a controller apparatus in the existing Wi-Fi EasyMesh network transfers controller apparatus authority to the smart device 703 that newly participates in the network. In contrast to this, when the public network to which the smart device 703 is connected is lower in performance than the public network to which the smart device 102 is connected, the smart device 703 stops operating as a controller apparatus. In this case, since there is no network managed at this point of time, the smart device 703 skips the processing in steps S607 to S611 in FIGS. 6A and 6B. The smart device 703 stops the controller function and activates the agent function. The smart device 703 is then connected as an agent apparatus to the smart device 102 and participates in the existing Wi-Fi EasyMesh network. Note that even in this case, since the topology is changed, the smart device 102 can notify the camera 101 of network configuration information.

Note that in the above case, an apparatus that can be newly connected to a public network participates in the existing Wi-Fi EasyMesh network. However, similar processing can be performed when such a network is newly constructed. For example, when the smart device 102 and the smart device 703 newly construct a Wi-Fi EasyMesh network, since these apparatuses can be directly connected to a public network, they become controller apparatuses initially. Subsequently, these apparatuses exchange performance information concerning the public network, and one apparatus maintains an operation as a controller apparatus while the other apparatus makes transition to an agent apparatus. The controller apparatus then constructs, for example, a Fronthaul SSID wireless LAN network, and the agent apparatus is wirelessly connected as a Backhaul STA to the network. This makes it possible to newly construct a Wi-Fi EasyMesh network between two apparatuses that can be connected to a public network.

As described above, when there are a plurality of apparatuses that can be connected to a public network, an apparatus having higher communication performance in the public network becomes a controller apparatus, whereas an apparatus having lower communication performance in the public network automatically makes transition to an agent apparatus. This makes a suitable apparatus become a controller apparatus without making the user give any consideration to which apparatus should be a controller apparatus, thereby improving the convenience for the user.

This embodiment has exemplified the processing of determining the role of the apparatus itself in accordance with whether it can be directly connected to a public network, and then determining again the role of the apparatus itself in accordance with the role of the counterpart apparatus. However, this is not exhaustive. For example, the apparatus may determine a temporary role in accordance with whether it can be connected to a public network, and may then determine a formal role in accordance with the role of the counterpart apparatus. That is, the apparatus, based on whether or not connection with a public network is possible, may temporarily make transition to an intermediate state in which the apparatus is neither a controller apparatus nor an agent apparatus, and may then determine a final role.

In addition, this embodiment has exemplified the case in which the apparatus determines a role in consideration of whether the apparatus can be directly connected to a public network. However, similar processing may be executed with respect to a predetermined network different from a public network. For example, the apparatus may determine a role in consideration of whether the apparatus can be directly (without via another apparatus included in a mesh network) connected to a local area network such as a corporate network or school network.

The present invention makes it possible to automatically and more properly select a controller that controls a network from apparatuses belonging to the network.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus comprising:
a participation unit configured to participate in a network that mutually connects base stations that provide a communication service to a terminal;
a determination unit configured to determine, in accordance with whether the apparatus can be connected to a public network in the network without via another apparatus, whether the apparatus operates as a role of a controller that controls the network or as a role of an agent that is managed by another apparatus that operates as the controller; and
an operation unit configured to operate as a function corresponding to determination made by the determination unit.

2. The communication apparatus according to claim 1, wherein the determination unit determines that the apparatus operates as the controller, if the communication apparatus can be connected to the public network without via another apparatus included in the network.

3. The communication apparatus according to claim 1, wherein the determination unit determines that the apparatus operates as the agent, if the communication apparatus cannot be connected to the public network without via another apparatus included in the network.

4. The communication apparatus according to claim 1, wherein upon detecting another apparatus operating as the controller in the network while the communication apparatus operates as the controller, the determination unit determines whether to transfer authority as the controller to the other apparatus based on performance of a public network to which the communication apparatus is connected and performance of a public network to which the other apparatus operating as the controller is connected.

5. The communication apparatus according to claim 4, wherein the determination unit determines not to transfer authority as the controller to the other apparatus if a communication rate in a public network to which the communication apparatus is connected is higher than a communication rate in the other public network to which another apparatus operating as the controller is connected.

6. The communication apparatus according to claim 4, wherein the determination unit determines to transfer authority as the controller to the other apparatus if a communication rate in a public network to which the communication apparatus is connected is lower than a communication rate in the other public network to which the other apparatus operating as the controller is connected.

7. The communication apparatus according to claim 4, further comprising a reception unit configured to receive a message complying with an IEEE1905.1 standard including information concerning another public network to which another apparatus operating as the controller is connected.

8. The communication apparatus according to claim 4, wherein if the communication rate in the public network to which the communication apparatus is connected is equal to the communication rate in the other public network to which the other apparatus operating as the controller is connected, the determination unit determines, based on wireless functions of the communication apparatus and the other apparatus, whether to transfer authority as the controller to the other apparatus.

9. The communication apparatus according to claim 4, further comprising a notification unit configured to, if it is determined that authority as the controller is transferred to the other apparatus operating as the controller, notify the other apparatus of topology information of the network by using a message complying with the IEEE1905.1 standard.

10. The communication apparatus according to claim 9, wherein the notification unit further notifies the topology information to another apparatus operating as the agent in the network.

11. The communication apparatus according to claim 4, further comprising a notification unit configured to, if it is determined that authority as the controller is transferred to the other apparatus operating as the controller, notify the other apparatus of information indicating a communication state of an apparatus included in the network by using a message complying with the IEEE1905.1 standard.

12. The communication apparatus according to claim 1, further comprising a search unit configured to search for a counterpart apparatus to be connected to the network if the communication apparatus starts operating as the controller or the agent.

13. The communication apparatus according to claim 12, wherein the search unit searches for the counterpart apparatus in accordance with a rule in the IEEE1905.1 standard if the communication apparatus is wiredly connected to the network.

14. The communication apparatus according to claim 12, wherein if the apparatus is wirelessly connected to the network, the search unit searches for the counterpart apparatus by using at least one of methods complying with a Wi-Fi Protected Setup (WPS) standard and a Device Provisioning Protocol (DPP) standard.

15. The communication apparatus according to claim 12, wherein if the search unit has not detected the controller in the network while the communication apparatus is operating as the agent, the determination unit determines that the communication apparatus stops operating as the agent and operates as the controller.

16. The communication apparatus according to claim 1, wherein the network is a Wi-Fi EasyMesh network.

17. A control method executed by a communication apparatus, the method comprising:
participating in a network that mutually connects base stations that provide a communication service to a terminal;
determining, in accordance with whether the apparatus can be connected to a public network in the network without via another apparatus, whether the apparatus operates as a role of a controller that controls the network or as a role of an agent that is managed by another apparatus that operates as the controller; and
operating as a function corresponding to the determining.

18. A non-transitory computer-readable storage medium that stores a program for causing a computer included in a communication apparatus to:
participate in a network that mutually connects base stations that provide a communication service to a terminal;
determine, in accordance with whether the apparatus can be connected to a public network in the network without via another apparatus, whether the apparatus operates as a role of a controller that controls the network or as a role of an agent that is managed by another apparatus that operates as the controller; and
operate as a function corresponding to the determination.
